(19) United States
(12) Patent Application Publication
(10) Pub. No.: US 2025/0270404 A1
(43) Pub. Date: Aug. 28, 2025

(54) BONDING RESIN

(71) Applicant: Stora Enso OYJ, Helsinki (FI)

(72) Inventors: Dimitri Areskogh, Bromma (SE); Ashar Zafar, Älta (SE); Huynh Tram Anh Pham, Älvsjö (SE)

(73) Assignee: Stora Enso OYJ, Helsinki (FI)

(21) Appl. No.: 18/867,365

(22) PCT Filed: May 17, 2023
(86) PCT No.: PCT/IB2023/055072

§ 371 Date: Nov. 19, 2024

(30) Foreign Application Priority Data
May 19, 2022 (SE) 2230156-8

(51) Int. Cl. C08L 97/00; C08J 3/05; C08J 3/24; C08K 5/544; C08K 7/20

(52) U.S. Cl. CPC C08L 97/005; C08J 3/05; C08J 3/247; C08K 5/544; C08K 7/20; C08J 2397/00; C08L 2203/12; C08L 2312/08

(57) ABSTRACT

The present invention relates to a bonding resin useful for example in the manufacture of insulation, such as mineral wool insulation or glass wool insulation. The invention also relates to a method for preparing the bonding resin and to the use thereof.

### FIELD OF THE INVENTION

The present invention relates to a bonding resin useful for example in the manufacture of insulation, such as mineral wool insulation or glass wool insulation. The invention also relates to a method for preparing the bonding resin and to the use thereof.

### BACKGROUND

Bonding resins are useful in fabricating articles, because they are capable of consolidating non-or loosely-assembled matter. For example, bonding resins enable two or more surfaces to become united. In particular, bonding resin may be used to produce products comprising consolidated fibers. Thermosetting bonding resins may be characterized by being transformed into insoluble and infusible materials by means of either heat or catalytic action. Examples of thermosetting bonding resins include a variety of phenol-aldehyde, urea-aldehyde, melamine-aldehyde, and other condensation-polymerization materials like polyurethane resins. Bonding resins containing phenol-aldehyde, resorcinol-aldehyde, phenol/aldehyde/urea, phenol/melamine/aldehyde, and the like are used for the bonding of fibers, textiles, plastics, rubbers, and many other materials.

The mineral wool and fiber board industries have historically used phenol-formaldehyde bonding resins to bind fibers. Phenol-formaldehyde type bonding resins provide suitable properties to the final products; however, environmental considerations have motivated the development of alternative binders. One such alternative bonding resin is a carbohydrate-based binder derived from reacting a carbohydrate and a multiprotic acid, for example according to US2007/0027283 and WO2009/019235. Another alternative bonding resin is the esterification products of a polycarboxylic acid reacted with a polyol, for example according to US2005/0202224. Since these binders do not utilize formaldehyde as a reagent, they have been collectively referred to as formaldehyde-free binders.

One area of development is to find a replacement for the phenol-formaldehyde type binders across the entire range of products in which they are used (e.g. fiberglass insulation, particle boards, office panels, and acoustical sound insulation). In particular, the previously developed formaldehyde-free bonding resins may not possess all the desired properties for all the products. For example, acrylic acid and poly(vinylalcohol) based binders have shown promising performance characteristics. However, these are relatively more expensive than phenol-formaldehyde binders, are derived essentially from petroleum-based resources, and have a tendency to exhibit lower reaction rates compared to the phenol-formaldehyde based bonding resins (requiring either prolonged cure times or increased cure temperatures). Carbohydrate-based bonding resins are made of relatively inexpensive precursors and are derived mainly from renewable resources; however, these bonding resins may also require reaction conditions for curing that are substantially different from those conditions under which the traditional phenol-formaldehyde binder system cured. Therefore, replacement of phenol-formaldehyde type binders with an existing alternative has not been readily achievable.

EP2566904 is directed to a binder formulation comprising the reaction products of a carbohydrate reactant and a polyamine and materials made therewith.

Lignin, an aromatic polymer is a major constituent in e.g. wood, being the most abundant carbon source on Earth second only to cellulose. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry.

Lignin, being a polyaromatic network, has been extensively investigated as a suitable substitute for phenol during production of phenol-formaldehyde adhesives. These are used during manufacturing of laminate and structural wood products such as plywood, oriented strand board and fiberboard. During synthesis of such adhesives, phenol, which may be partially replaced by lignin, is reacted with formaldehyde in the presence of either basic or acidic catalyst to form a highly cross-linked aromatic resins termed novolacs (when utilizing acidic catalysts) or resoles (when utilizing basic catalysts). Currently, only limited amounts of the phenol can be replaced by lignin due to the lower reactivity of lignin.

A particular problem when preparing insulation products is to obtain an appropriate balance between dry strength and wet strength properties, which largely depend on the bonding resin used. If the insulation product is intended for use such that it is exposed to moisture or water, such as for outdoor use, it is essential to use a bonding resin that provides sufficient wet strength.

### SUMMARY OF THE INVENTION

It has now surprisingly been found that it is possible to easily prepare a bonding resin, suitable for example for use in the production of insulation, in which the use of formaldehyde can be avoided. It has also been found that the bonding resin provides improved wet strength properties and improved balance between dry strength and wet strength properties, making it particularly useful in the manufacture of insulation. Further, it has been found that the strength properties can be improved by including epoxy-based crosslinker in the bonding resin.

Further, it has been found that when lignin is provided in the form of an aqueous solution comprising ammonia and/or organic base, the phenolic hydroxyl groups in the lignin structure are deprotonated and free to react with other components of a bonding resin. This improves the reactivity and performance of the binder. Therefore, providing the lignin in the form of an aqueous solution comprising ammonia and/or an organic base speeds up the reaction significantly and hence facilitates the curing of the bonding resin, when manufacturing for example mineral wool insulation or glass wool insulation.

Furthermore, by providing lignin in the form an aqueous solution of lignin comprising ammonia and/or an organic base the risk of degrading for example glass wool and mineral wool fibers is minimized.

The present invention is thus directed to a bonding resin comprising a reaction product of a carbohydrate reactant, lignin, epoxy-based crosslinker and a polyamine, wherein the carbohydrate reactant is selected from monosaccharide, a disaccharide or an oligosaccharide and wherein the polyamine is a primary polyamine selected from a group consisting of a diamine, triamine, tetraamine and pentaamine, and wherein the polyamine is H₂N-Q-NH₂, wherein Q is C₁-C₁₀ alkyl, cycloalkyl, C₁-C₁₀ heteroalkyl, or cycloheteroalkyl, each of which is optionally substituted; and wherein the lignin is provided as a solution and wherein the weight ratio of the carbohydrate to the polyamine is in the range of from 1:100 to 100:1 and wherein the weight ratio of the lignin to carbohydrate, calculated on the basis of dry lignin and dry carbohydrate, is between 1:100 and 100:1 and wherein the amount of lignin in the bonding resin, calculated on the basis of dry lignin and dry bonding resin, is in the range of from 5 wt-% to 30 wt-%.

The present invention is also directed to a fibrous insulation product comprising the bonding resin according to the present invention.

### DETAILED DESCRIPTION

It is intended throughout the present description that the expression “lignin” embraces any kind of lignin, e.g. lignin originated from hardwood, softwood or annular plants. Preferably the lignin is an alkaline lignin generated in e.g. the Kraft process. Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%. Thus, the lignin used according to the method of the present invention preferably contains less than 10%, preferably less than 5% impurities. The lignin may then be separated from the black liquor by using the process disclosed in WO2006031175. The lignin may then be separated from the black liquor by using the process referred to as the LignoBoost process. The lignin may be provided in the form of particles, such as particles having an average particle size of from 50 micrometers to 500 micrometers. The lignin may also be provided in the form of agglomerates having an average diameter of from 0.01 to 10 mm, such as from 0.1 to 5 mm.

The reactivity of the lignin can be increased by modifying the lignin by glyoxylation, etherification, esterification, amination or any other method where lignin hydroxyl content or carboxylic content or amine content or thiol content is increased. Preferably, the lignin used according to the present invention is not modified chemically after its extraction from wood and isolation. More specifically, the lignin is preferably not subjected to oxidation after having been isolated from the Kraft process.

An aqueous solution of lignin comprising ammonia and/or an organic base can be prepared by methods known in the art, such as by mixing lignin and ammonia and/or organic base with water. The pH of the aqueous solution of lignin comprising ammonia and/or an organic base is preferably in the range of from 8 to 14, more preferably in the range of from 9 to 11 or 10 to 11.

Examples of organic bases include amines, such as primary, secondary and tertiary amines and mixtures thereof. Preferably, the organic base is selected from the group consisting of methylamine, ethylamine, propylamine, butylamine, ethylenediamine, methanolamine, ethanolamine, aniline, cyclohexylamine, benzylamine, dimethylamine, diethylamine, dipropylamine, dibutylamine, dimethanolamine, diethanolamine, diphenylamine, phenylmethylamine, phenylethylamine, hexamethylenediamine, polyetheramine, dicyclohexylamine, piperazine, imidazole, 2-methylimidazole, 2-ethylimidazole, 2-ethyl-4-methylimidazole, 2-isopropylimidazole, 2-phenylimidazole, 2-methylimidazoline, 2-phenylimidazoline, trimethylamine, triethylamine, dimethylhexylamine, N-methylpiperazine, dimethylbenzylamine, aminomethyl propanol, tris(dimethylaminomethyl)phenol and dimethylaniline or mixtures thereof. The total amount of ammonia and/or organic base in the aqueous solution is preferably in the range of from 0.1 wt-% to 20 wt-%, preferably 0.1 wt-% to 10 wt-%, of the total weight of the aqueous solution comprising water, lignin and ammonia and/or an organic base. The amount of lignin in the aqueous solution of lignin comprising ammonia and/or an organic base is preferably from 1 wt-% to 60 wt-% of the solution, such as from 10 wt-% to 30 wt-% of the solution. The aqueous solution of lignin comprising ammonia and/or an organic base comprises less than 1 wt-% alkali and less than 1 wt-% inorganic base. More preferably, the aqueous solution of lignin comprising ammonia and/or an organic base does not comprise alkali and does not comprise inorganic base.

The amount of lignin in the bonding resin is preferably from 5 wt-% to 50 wt-%, calculated as the dry weight of lignin and the total weight of the bonding resin.

As used herein, a polyamine is an organic compound having two or more amine groups. As used herein, a primary polyamine is an organic compound having two or more primary amine groups (—NH₂). Within the scope of the term primary polyamine are those compounds which can be modified in situ or isomerize to generate a compound having two or more primary amine groups (—NH₂). The polyamine is a primary polyamine.

The polyamine used in the bonding resin according to the present invention may be a molecule having the formula of H₂N-Q-NH₂, wherein Q is an alkyl, cycloalkyl, heteroalkyl, or cycloheteroalkyl, each of which may be optionally substituted. In one embodiment, Q is an alkyl selected from a group consisting of C₂-C₂₄ alkyl. In one embodiment, Q is an alkyl selected from a group consisting of C₂-C₈ alkyl. In one embodiment, Q is an alkyl selected from a group consisting of C₃-C₇ alkyl. In one embodiment, Q is a C₆ alkyl. In one embodiment, Q is selected from the group consisting of a cyclohexyl, cyclopentyl or cyclobutyl. In one embodiment, Q is a benzyl.

As used herein, the term “alkyl” includes a chain of carbon atoms, which is optionally branched. The alkyl is of limited length, including C₁-C₂₄, C₁-C₁₂, C₁-C₈, C₁-C₆, or C₁-C₄. Shorter alkyl groups may add less hydrophilicity to the compound and accordingly will have different reactivity towards the carbohydrate reactant and lignin and solubility in a binder solution.

As used herein, the term “cycloalkyl” includes a chain of carbon atoms, which is optionally branched, where at least a portion of the chain in cyclic. Cycloalkylalkyl is a subset of cycloalkyl. Cycloalkyl may be polycyclic. Examples of cycloalkyls include, but are not limited to, cyclopropyl, cyclopentyl, cyclohexyl, 2-methylcyclopropyl, cyclopentyleth-2-yl, adamantyl, and the like. Chain forming cycloalkyl is of limited length, including C₃-C₂₄, C₃-C₁₂, C₃-C₈, C₃-C₆, or C₅-C₆. Shorter alkyl chains forming cycloalkyl may add less lipophilicity to the compound and accordingly will have different behavior.

As used herein, the term “heteroalkyl” includes a chain of atoms that includes both carbon and at least one heteroatom, and is optionally branched. Illustrative heteroatoms include nitrogen, oxygen, and sulfur. Illustrative heteroatoms also include phosphorus, and selenium. In one embodiment, a heteroalkyl is a polyether. As used herein, the term “cycloheteroalkyl” including heterocyclyl and heterocycle, includes a chain of atoms that includes both carbon and at least one heteroatom, such as heteroalkyl, and is optionally branched, where at least a portion of the chain is cyclic. Illustrative heteroatoms include nitrogen, oxygen, and sulfur. Illustrative heteroatoms also include phosphorus, and selenium. Illustrative cycloheteroalkyl include, but are not limited to, tetrahydrofuryl, pyrrolidinyl, tetrahydropyranyl, piperidinyl, morpholinyl, piperazinyl, homopiperazinyl and the like.

The term “optionally substituted” as used herein includes the replacement of hydrogen atoms with other functional groups on the radical that is optionally substituted. Such other functional groups illustratively include, but are not limited to, amino, hydroxyl, halo, thiol, alkyl, haloalkyl, heteroalkyl, aryl, arylalkyl, arylheteroalkyl, nitro, sulfonic acids and derivatives thereof, carboxylic acids and derivatives thereof, and the like. Illustratively, any of amino, hydroxyl, thiol, alkyl, haloalkyl, heteroalkyl, aryl, arylalkyl, arylheteroalkyl, and/or sulfonic acid is optionally substituted.

In one embodiment of the present invention, the polyamine is selected from a group consisting of a diamine, triamine, tetraamine, and pentamine. In one embodiment, the polyamine is a diamine selected from a group consisting of hexamethylenediamine, 1,6-diaminohexane, 1,5-diamino-2-methylpentane and 3-(aminomethyl)-3,5,5-trimethylcyclohexan-1-amine. In one embodiment, the diamine is 1,6-diaminohexane. In one embodiment, the polyamine is a triamine selected from a group consisting of diethylenetriamine, 1-piperazineethaneamine, and bis(hexamethylene)triamine. In one embodiment, the polyamine is a tetramine such as triethylenetetramine. In one embodiment, the polyamine is a pentamine, such as tetraethylenepentamine. In one embodiment, the primary polyamine is a polyether-polyamine. In one embodiment, the polyether-polyamine is a diamine or a triamine.

The carbohydrate reactant is a monosaccharide, a disaccharide or an oligosaccharide. In one embodiment, the carbohydrate is a monosaccharide in its aldose or ketose form. In one embodiment, the carbohydrate may be a reducing sugar. In one embodiment, the carbohydrate reactant is selected from a group consisting of dextrose, xylose, fructose, dihydroxyacetone, and mixtures thereof. In one embodiment, the carbohydrate reactant is a disaccharide, such as sucrose, lactose or maltose. In one embodiment, the carbohydrate reactant is an oligosaccharide such as chitosan.

The weight ratio of the carbohydrate to the polyamine is in the range of from 1:100 to 100:1, calculated on the basis of dry solids. Preferably, the weight ratio of the carbohydrate reactant to the polyamine is in the range of from 20:1 to 1:20, and more preferably in the range of from 10:1 to 1:10, most preferably in the range of from 1:3 to 10:1, such as from 1:2 to 5:1 or in the range of from 1:1.1 to 1.1:1, calculated on the basis of dry solids.

The weight ratio of the lignin to carbohydrate, calculated on the basis of dry solids, is between 100:1 and 1:100, preferably in the range of 20:1 and 1:20 and more preferably in the range of from 10:1 to 1:10, most preferably in the range of from 1:1 to 10:1, such as from 1:1 to 5:1 or from 2:1 to 8:1 or from 2:1 to 5:1 or in the range of from 6:1 to 1:1, calculated on the basis of dry solids.

The weight ratio of the lignin to polyamine, calculated on the basis of dry solids, is between 100:1 and 1:100, preferably in the range of 20:1 and 1:20 and more preferably in the range of from 10:1 to 1:10, most preferably in the range of from 2:1 to 10:1, such as from 1:1 to 5:1 or from 2:1 to 5:1 or in the range of from 6:1 to 1:1, calculated on the basis of dry solids.

The epoxy-based crosslinker is preferably selected from glycerol diglycidyl ether, polyglycerol polyglycidyl ether, glycerol triglycidyl ether, sorbitol polyglycidyl ether, alkoxylated glycerol polyglycidyl ether, trimethylolpropane triglycidyl ether, trimethylolpropane diglycidyl ether, polyoxypropylene glycol diglycidylether, polyoxypropylene glycol triglycidyl ether, diglycidylether of cyclohexane dimethanol, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl-, triglycidyl- or polyglycidyl-ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound or epoxidized plant-based oil, tris(4-hydroxyphenyl) methane triglycidyl ether, N,N-bis (2,3-epoxypropyl)aniline, p-(2,3-epoxypropoxy-N,N-bis(2,3-epoxypropyl)aniline, diglycidyl ether of bis-hydroxymethylfuran, and/or diglycidyl ether of terminal diol having a linear carbon chain of 3-6 carbon atoms.

The weight ratio of the epoxy-based crosslinker to the lignin is preferably in the range of from 1:100 to 100:1, more preferably in the range of from 1:100 to 10:1, such as from 2:100 to 1:1 or from 5:100 to 1:1, calculated on the basis of dry solids.

The weight ratio of the epoxy-based crosslinker to the carbohydrate reactant is preferably in the range of from 1:100 to 100:1, more preferably in the range of from 1:10 to 10:1, such as from 1:5 to 5:1, calculated on the basis of dry solids.

The solid content of the bonding resin before curing is preferably in the range of from 10 to 70%, such as in the range of from 15 to 50%.

The bonding resin may also comprise additives, such as urea, tannin, surfactants, dispersing agents and fillers. The bonding resin may also comprise plasticizer. In one embodiment, the bonding resin does not comprise plasticizer. As used herein, the term “plasticizer” refers to an agent that, when added to lignin, makes the lignin softer and more flexible, to increase its plasticity by lowering the glass transition temperature (Tg) and improve its flow behavior. Examples of plasticizers include polyols, alkyl citrates, organic carbonates, phthalates, adipates, sebacates, maleates, benzoates, trimellitates and organophosphates. Polyols include for example polyethylene glycols, polypropylene glycols, glycerol, diglycerol, polyglycerol, butanediol, sorbitol and polyvinyl alcohol. Alkyl citrates include for example triethyl citrate, tributyl citrate, acetyl triethyl citrate and trimethyl citrate. Organic carbonates include for example ethylene carbonate, propylene carbonate, glycerol carbonate and vinyl carbonate. Further examples of plasticizers include polyethylene glycol ethers, polyethers, hydrogenated sugars, triacetin and solvents used as coalescing agents like alcohol ethers. In one embodiment of the present invention, the plasticizer is a polyol, such as a polyol selected from the group consisting of polyethylene glycols and polypropylene glycols. If the resin comprises a plasticizer, the weight ratio between plasticizer and lignin, calculated on the basis of dry weight of each component, is preferably from 0.1:10 to 10:1. Preferably, the weight ratio between plasticizer (if present) and lignin, calculated on the basis of dry weight of each component, is from 0.1:10 to 10:10, such as from 1:10 to 5:10. The bonding resin may also comprise coupling agent. Coupling agents are for example silane-based coupling agents. In one embodiment, the bonding resin does not comprise coupling agent.

A filler and/or hardener can also be added to the bonding resin. Examples of such fillers and/or hardeners include limestone, cellulose, sodium carbonate, and starch. In one embodiment, the bonding resin does not comprise filler and/or hardener.

Preferably, the bonding resin according to the present invention does not contain formaldehyde. Preferably, the bonding resin does not contain phenol.

Preferably, the bonding resin according to the present invention does not contain basic catalyst. Further, it is preferred that a basic catalyst is not used in the production of the bonding resin according to the present invention.

The fibrous material used according to the present invention is for example mineral fibers (such as glass fibers, slag wool fibers, and rock wool fibers), aramid fibers, ceramic fibers, metal fibers, carbon fibers, polyimide fibers, polyester fibers, and rayon fibers. Such fibers are substantially unaffected by exposure to temperatures above about 120° C. In one embodiment, the insulating fibers are glass fibers. In one embodiment, the insulating fibers are rock wool fibers. In one embodiment, the mineral fibers are present in an insulation product according to the present invention in the range from about 70% to about 99% by weight.

In one embodiment, fibrous material comprises cellulosic fibers. For example, the cellulosic fibers may be wood shavings, sawdust, wood pulp, or ground wood. In one embodiment, the cellulosic fibers may be other natural fibers such as jute, flax, hemp, and straw.

As used herein, the term binder solution is the solution of chemicals which can be substantially dehydrated to form an uncured bonding resin. As used herein, the bonding resin may be cured, uncured, or partially cured. The composition of the uncured bonding resin is referred to as an uncured bonding resin. An uncured bonding resin is a substantially dehydrated mixture of chemicals which can be cured to form a cured bonding resin. Substantially dehydrated means that the solvent (typically water or a mixture comprising water) used to make the binder solution is vaporized to the extent that the viscosity of the remaining material (comprising the binder reactants and solvent) is sufficiently high to create cohesion between the loosely assembled matter; thus, the remaining material is an uncured bonding resin. In one embodiment, the solvent is less than 65% of the total weight of the remaining material. In one embodiment, a substantially dehydrated bonding resin has a moisture content between about 5% and about 65% water by weight of total binder. In one embodiment, the solvent may be less than 50% of the total weight of the remaining material. In one embodiment, the solvent may be less than 35% of the total weight of the remaining material. In one embodiment, a substantially dehydrated bonding resin has between about 10% and about 35% water by weight of total bonding resin. In one embodiment, the solvent may comprise less than about 20% of the total weight of the remaining material.

As used herein, the term cured bonding resin describes the polymeric product of curing the uncured bonding resin. The cured bonding resin may have a characteristic brown to black color and tends to absorb light over a broad range of wavelengths. Since the polymer of the cured bonding resin is extensively cross-linked, the cured bonding resin is substantially insoluble. For example, the bonding resin is essentially insoluble in water. As described herein, the uncured bonding resin provides sufficient binding capacity to consolidate fibers; however, the cured bonding resin imparts the robust, long-lasting durability and physical properties commonly associated with cross-linked polymers.

The bonding resin reactants described herein are soluble in water and when combined in water, a binder solution is obtained. In one embodiment, a surfactant is included in the aqueous solution to increase the solubility or dispersability of one or more bonding resin reactants or additives. For example, a surfactant may be added to the aqueous binder solution to enhance the dispersibility of a particulate additive. In one embodiment, a surfactant is used to create an emulsion with a non-polar additive or binder reactant. In one embodiment, the binder solution comprises about 0.01% to about 5% surfactant by weight based on the weight of the binder solution.

In one embodiment, the binder solution is prepared by first mixing lignin in ammonia with carbohydrate reactant and epoxy-based crosslinker, followed by addition of polyamine.

In one embodiment, the binder solution is prepared by adding carbohydrate reactant and polyamine to a mixture of lignin in the form of a solution, wherein the epoxy-based crosslinker has been added to the solution before addition of carbohydrate reactant and polyamine.

In one embodiment, the binder solution is prepared by first mixing carbohydrate reactant and polyamine and subsequently adding lignin in the form of a solution and the epoxy-based crosslinker. In one embodiment, carbohydrate reactant and polyamine is mixed for at least one minute, such as for at least 2 minutes or for at least 5 minutes or for at least 10 minutes, before addition of lignin in the form of a solution and epoxy-based crosslinker. Preferably, the step of mixing the carbohydrate reactant and the polyamine, before the addition of lignin in the form of a solution and epoxy-based cross-linker, takes place at a temperature in the range of from 10° C. to 30° C., such as at room temperature or at a temperature of about 15° C. to 25° C. In one embodiment, the binder solution is prepared by first mixing lignin solution with carbohydrate reactant and epoxy-based crosslinker until the carbohydrate is dissolved, followed by addition of polyamine. In one embodiment, the binder solution is prepared by first mixing lignin solution with carbohydrate reactant and mixing until the carbohydrate is dissolved, followed by addition of epoxy-based crosslinker and polyamine.

The binder solutions described herein can be applied to fibrous material (e.g., sprayed onto a mat or sprayed onto the fibers as they enter a forming region), during production of fibrous insulation products. Once the binder solution is in contact with the mineral fibers the residual heat from the mineral fibers (note that glass fibers for example are made from molten glass and thus may contain residual heat) and the flow of air through and/or around the product will cause a portion of the water to evaporate from the binder solution. Removing the water leaves the remaining components of the bonding resin on the fibers as a coating of viscous or semi-viscous high-solids mixture. This coating of viscous or semi-viscous high-solids mixture functions as a bonding resin. At this point, the mat has not been cured. In other words, the uncured bonding resin functions to bind the fibers in the mat.

The above described uncured bonding resins can be cured. For example, the process of manufacturing a cured insulation product may include a subsequent step in which heat is applied to cause a chemical reaction in the uncured bonding resin. For example, in the case of making fiberglass insulation products or other mineral fiber insulating products, after the binder solution has been applied to the fibers and dehydrated, the uncured insulation product may be transferred to a curing oven. In the curing oven the uncured insulation product is heated (e.g. to from about 150° C. to about 320° C.), causing the bonding resin to cure. The cured bonding resin is thus a formaldehyde-free, water-resistant bonding resin that binds the fibers of the fibrous insulation product together. The drying and thermal curing may occur either sequentially, simultaneously, contemporaneously, or concurrently.

An uncured fiber product typically comprises about 3% to about 40% of dry binder solids (total uncured solids by weight). In one embodiment, the uncured fiber product comprises about 5% to about 25% of dry binder solids. In one embodiment, the uncured fiber product comprises about 50% to about 97% fibers by weight.

A cured bonding resin is the product of curing the bonding resin. The term cured indicates that the bonding resin has been exposed to conditions that initiate a chemical change. Examples of these chemical changes may include, but are not limited to, (i) covalent bonding, (ii) hydrogen bonding of binder components, and (iii) chemically cross-linking the polymers and/or oligomers in the bonding resin. These changes may increase the bonding resin's durability and solvent resistance as compared to the uncured bonding resin. Curing a bonding resin may result in the formation of a thermoset material. In addition, a cured bonding resin may result in an increase in adhesion between the matter in a collection as compared to an uncured bonding resin. Curing can be initiated by, for example, heat, microwave radiation, and/or conditions that initiate one or more of the chemical changes mentioned above.

In a situation where the chemical change in the bonding resin results in the release of water, e.g., polymerization and cross-linking, a cure can be determined by the amount of water released above that which would occur from drying alone. The techniques used to measure the amount of water released during drying as compared to when a bonding resin is cured, are well known in the art.

### EXAMPLES

### Example 1—Preparation of Lignin-Ammonia Solution

Lignin ammonia solution was prepared first by adding 211 g of powder lignin (solid content 95%, as determined with a laboratory infra-red moisture analyzer) and 685 g of water to a 1 L glass reactor at ambient temperature and stirred until the lignin was fully and evenly dispersed. Then, 104 g of 28-30% ammonia solution was added to the lignin dispersion. The composition was stirred for 60 minutes to ensure complete dissolution of the lignin.

### Example 2—Preparation of Lignin-Ammonia Solution with Plasticizer

Lignin-ammonia solution with plasticizer was prepared by adding 211 g of powder lignin (solid content 95%, as determined with a laboratory infra-red moisture analyzer), 685 g of water and 50 g of PEG400 to a 1 L glass reactor at ambient temperature and stirred until the lignin was fully and evenly dispersed. Then, 104 g of 28-30% ammonia solution was added to the lignin dispersion. The composition was stirred for 60 minutes to ensure complete dissolution of the lignin.

### Example 3—Preparation of Glass Bar Samples for Mechanical Testing

A binder solution was, if necessary, diluted with water and combined with a 1% solution of 3-Aminopropyl trimethoxysilane (APTES) in water to obtain a final solution with a total concentration of 20-23% (total DS) and a concentration of APTES of 0.5%.

This binder was combined with spherical glass beads (Sibelco AbraVer®, average size 300-400 μm), a model system traditionally employed in the field to mimic resin interaction with glass fibers, and stirred thoroughly with a spatula to obtain a thick homogeneous paste with a binder-on-glass concentration of 4%.

This paste was transferred to a silicone mold consisting of 8 identical rectangular cavities with a length of 215 mm, width of 107 mm and thickness of 16 mm.

The paste was distributed equally in all 8 cavities and the silicone mold was transferred to an oven and subjected to heating at 200° C. for 60 min.

After the heating, the mold was allowed to cool to room temperature and the 8 identical solid bars were separated from the mold and stored for further analysis.

### Example 4—Mechanical Performance of Glass Bar Samples

The mechanical performance of the glass bars is measured as dry strength (strength of dry glass bars) and wet strength (strength of glass bars after conditioning in water at 80° C. for 2h).

The glass bars were divided into two sets for dry and wet strength. The samples for dry strength were analyzed as-is. The samples for wet strength were analyzed immediately after conditioning in water at 80° C. for 2 h.

Weight of the samples before and after conditioning is obtained to measure the water uptake of the samples.

The strength is measured as follows; the dimensions of the glass bar is obtained with a caliper. The glass bar is mounted on a 65 mm supporting fixture consisting of two anvils, equally spaced from the center point. An upper anvil is slowly lowered at the center point with a constant rate. Force at the fracture point of the specimen is recorded and using the dimensions of the bar, converted to strength at break.

### Example 5

Binder composition was prepared by weighing 41 g of lignin solution from the example 2, 4.9 g of Jeffamine T403 (polyetheramine), 3.3 g of dextrose monohydrate, 2.1 g of polyethylene glycol diglycidyl ether, 13 g of water and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 1.

TABLE 1
Flexural Strength of the sand bars with and without conditioning

| | Flexural Strength | Flexural Strength after |
|---|---|---|
| | without conditioning | conditioning |
| | [MPa] | [MPa] |
| Sand bars | 17.8 | 7.1 |

### Example 6

Binder composition was prepared by weighing 51.5 g of lignin solution from the example 2, 3.1 g of Jeffamine T403, 2.1 g of dextrose, 2.6 g of polyethylene glycol diglycidyl ether, 7 g of water and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm. Glass bars were post-cured for 24 hours and soaked in a water bath at 80° C. for 2 hours.

The glass bars were evaluated with 3-point bending test. The flexural strength before and after water soaking is given in the Table 2.

TABLE 2
Flexural Strength of the sand bars with and without conditioning

| | Flexural Strength | Flexural Strength after |
|---|---|---|
| | without conditioning | conditioning |
| | [MPa] | [MPa] |
| Sand bars | 7.2 | 5.1 |

### Example 7

Binder composition was prepared by weighing 48.5 g of lignin solution from the example 2, 2.9 g of Jeffamine T403, 1.9 g of dextrose, 1 g of polyethylene glycol diglycidyl ether, 10 g of water and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 3.

TABLE 3
Flexural Strength of the sand bars with and without conditioning

| | Flexural Strength | Flexural Strength after |
|---|---|---|
| | without conditioning | conditioning |
| | [MPa] | [MPa] |
| Sand bars | 5.5 | 6.7 |

### Example 8

Binder composition was prepared by weighing 51.3 g of lignin solution from the example 2, 1.6 g of Jeffamine T403, 1 g of dextrose, 2.6 g of polyethylene glycol diglycidyl ether, 10 g of water and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 4.

TABLE 4
Flexural Strength of the sand bars with and without conditioning

| | Flexural Strength | Flexural Strength after |
|---|---|---|
| | without conditioning | conditioning |
| | [MPa] | [MPa] |
| Sand bars | 4.8 | 4.4 |

### Example 9

Binder composition was prepared by weighing 56 g of lignin solution from the example 1, 3.4 g of Jeffamine T403, 2.2 g of dextrose, 1.1 g of polyethylene glycol diglycidyl ether, 15 g of water and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 5.

TABLE 5
Flexural Strength of the sand bars with and without conditioning

| | Flexural Strength | Flexural Strength after |
|---|---|---|
| | without conditioning | conditioning |
| | [MPa] | [MPa] |
| Sand bars | 7.5 | 7.6 |

### Example 10

A solution was prepared by weighing and stirring 2.3 g dextrose, 4.5 g hexamethylenediamine (HMDA) and 4.5 g water. The solution was added to the binder composition of 45 g of lignin solution from the example 2, 2.3 g of polyethylene glycol diglycidyl ether and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 6.

TABLE 6
Flexural Strength of the sand bars with and without conditioning

| | Flexural Strength | Flexural Strength after |
|---|---|---|
| | without conditioning | conditioning |
| | [MPa] | [MPa] |
| Sand bars | 6.4 | 4.6 |

### Example 11

A solution was prepared by weighing and stirring 1.8 g maltose, 2.7 g Jeffamine T403 and 9 g water. The solution was added to the binder composition of 45 g of lignin solution from the example 2, 2.3 g of polyethylene glycol diglycidyl ether and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 7.

TABLE 7
Flexural Strength of the sand bars with and without conditioning

| | Flexural Strength | Flexural Strength after |
|---|---|---|
| | without conditioning | conditioning |
| | [MPa] | [MPa] |
| Sand bars | 6.4 | 3.2 |

### Example 12

Binder composition was prepared by weighing 51.5 g of lignin solution from the example 2, 3.1 g of Jeffamine T403, 2.1 g of dextrose, 4 g of water and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 8.

TABLE 8
Flexural Strength of the sand bars with and without conditioning

| | Flexural Strength | Flexural Strength after |
|---|---|---|
| | without conditioning | conditioning |
| | [MPa] | [MPa] |
| Sand bars | 5.2 | 5.5 |

### Example 13

A solution was prepared by weighing and stirring 20 g dextrose, 20 g hexamethylene diamine (HMDA), 60 g water. Binder composition was prepared by weighing 39.2 g of the lignin HMDA solution, 5.2 g of dextrose, 15 g of water and 4 g of 1% of 3-aminopropyl trimethoxysilane into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 9.

TABLE 9
Flexural Strength of the sand bars with and without conditioning

| | Flexural Strength | Flexural Strength after |
|---|---|---|
| | without conditioning | conditioning |
| | [MPa] | [MPa] |
| Sand bars | 6.0 | 3.1 |

### Example 14 (Comparative)

A solution was prepared by weighing and stirring 12 g dextrose, 18 g Jeffamine T403, 52.8 9 g water and 17.2 g of 29% ammonia solution. Then, 60 g of the solution and 4 g of 1% of 3-aminopropyl trimethoxysilane were added into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 10.

TABLE 10
Flexural Strength of the sand bars with and without conditioning

| | Flexural Strength | Flexural Strength after |
|---|---|---|
| | without conditioning | conditioning |
| | [MPa] | [MPa] |
| Sand bars | 7.4 | 2.3 |

### Example 15 (Comparative)

A solution was prepared by weighing and stirring 12 g dextrose, 18 g Jeffamine T403, 52.8 9 g water and 17.2 g of 29% ammonia solution. Then, 51.4 g of the solution, 2.6 g of polyethylene glycol diglycidyl ether, 6 g water and 4 g of 1% of 3-aminopropyl trimethoxysilane were added into a 250 ml plastic container and was stirred with a wooden stick for 2 minutes. Then, 450 g glass beads were weighed into a beaker and the lignin mixture were poured on top of the sand and mixed for 2 minutes. Then, the glass bars were prepared by putting the glass-binder mixture into a silicon mould for baking in an oven at 200° C. for 1 hours. All glass bars were hard and stable after curing in the oven. The size of the bar for each test is height×thickness×length: 26 mm×18 mm×103 mm.

Glass bars were post-cured for 24 hours and soaked in a water bath at 80° C. for 2 hours.

The glass bars were evaluated with 3-point bending test. The flexural strength before and after water soaking is given in the Table 11.

TABLE 11
Flexural Strength of the sand bars with and without conditioning

| | Flexural Strength | Flexural Strength after |
|---|---|---|
| | without conditioning | conditioning |
| | [MPa] | [MPa] |
| Sand bars | 5.1 | 0.6 |

In view of the above detailed description of the present invention, other modifications and variations will become apparent to those skilled in the art. However, it should be apparent that such other modifications and variations may be effected without departing from the spirit and scope of the invention.

1. A bonding resin comprising:
a reaction product of a carbohydrate reactant, lignin, epoxy-based crosslinker, and a polyamine,
wherein the carbohydrate reactant is selected from a group consisting of: monosaccharide, a disaccharide, and an oligosaccharide,
wherein the polyamine is a primary polyamine selected from a group consisting of: a diamine, triamine, tetraamine, and pentaamine,
wherein the polyamine is H₂N-Q-NH₂, wherein Q is C₁-C₁₀ alkyl, cycloalkyl, C₁-C₁₀ heteroalkyl, or cycloheteroalkyl, each of which is optionally substituted, and
wherein the lignin is provided as a solution,
wherein a weight ratio of the carbohydrate reactant to the polyamine is in a range of from 1:100 to 100:1,
wherein a weight ratio of the lignin to the carbohydrate reactant, calculated on a basis of dry lignin and dry carbohydrate reactant, is between 1:100 and 100:1, and
wherein an amount of lignin in the bonding resin, calculated on a basis of dry lignin and dry bonding resin, is in a range of from 1 wt-% to 50 wt-%.

2. The bonding resin according to claim 1, wherein the carbohydrate reactant is a disaccharide.

3. The bonding resin according to claim 2, wherein the disaccharide is selected from a group consisting of: sucrose, lactose, and maltose.

4. The bonding resin according to claim 1, wherein the polyamine is selected from a group consisting of: hexamethylenediamine, polyetheramine, 1,6-diaminohexane, 1,5-diamino-2-methylpentane, 3-(aminomethyl)-3,5,5-trimethylcyclohexan-1-amine, diethylenetriamine, 1-piperazineethaneamine, bis(hexamethylene)triamine, triethylenetetramine, and tetraethylenepentamine.

5. The bonding resin according to claim 1, wherein the lignin is not chemically modified after the lignin is extracted from wood and isolated.

6. The bonding resin according to claim 1, wherein the lignin solution is a solution of lignin in ammonia, an organic base, or both.

7. The bonding resin according to claim 1, wherein the weight ratio of the lignin to the carbohydrate reactant is in a range of from 1:1 to 5:1.

8. The bonding resin according to claim 1, wherein a weight ratio of the lignin to the polyamine, calculated on a basis of dry solids, is from 2:1 to 5:1.

9. The bonding resin according to claim 1, wherein a weight ratio of the epoxy-based crosslinker to the lignin is in a range of from 1:100 to 10:1, calculated on a basis of dry solids.

10. The bonding resin according to claim 1, wherein the epoxy-based crosslinker is selected from a group consisting of: glycerol diglycidyl ether, polyglycerol polyglycidyl ether, glycerol triglycidyl ether, sorbitol polyglycidyl ether, alkoxylated glycerol polyglycidyl ether, trimethylolpropane triglycidyl ether, trimethylolpropane diglycidyl ether, polyoxypropylene glycol diglycidylether, polyoxypropylene glycol triglycidyl ether, diglycidylether of cyclohexane dimethanol, resorcinol diglycidyl ether, isosorbide diglycidyl ether, pentaerythritol tetraglycidyl ether, ethylene glycol diglycidyl ether, polyethylene glycol diglycidyl ether having 2-9 ethylene glycol units, propylene glycol diglycidyl ether having 1-5 propylene glycol units, diglycidyl-, triglycidyl- or polyglycidyl-ether of a carbohydrate, diglycidyl-, triglycidyl- or polyglycidyl-ester of a carbohydrate, diglycidyl-ether or diglycidyl ester of salicylic acid, vanillic acid, or 4-hydroxybenzoic acid, an epoxidized or glycidyl substituted plant-based phenolic compound or epoxidized plant-based oil, tris(4-hydroxyphenyl)methane triglycidyl ether, N,N-bis(2,3-epoxypropyl)aniline, p-(2,3-epoxypropoxy-N,N-bis(2,3-epoxypropyl)aniline, diglycidyl ether of bis-hydroxymethylfuran, diglycidyl ether of terminal diol having a linear carbon chain of 3-6 carbon atoms, and combinations thereof.

11. A fibrous insulation product comprising:
the bonding resin according to claim 1 and,
fibrous material.

12. The fibrous insulation product according to claim 11, wherein the fibrous material is selected from a group consisting of: glass fibers, mineral fibers, aramid fibers, ceramic fibers, metal fibers, carbon fibers, polyimide fibers, polyester fibers, rayon fibers, and cellulose fibers.

13. The fibrous insulation product according to claim 11, wherein the fibrous material is selected from a groups consisting of: glass fibers and mineral fibers.

14. A process for preparation of a bonding resin, the process comprising:
mixing a carbohydrate reactant selected from a group consisting of a monosaccharide, a disaccharide, and an oligosaccharide with a primary polyamine selected from a group consisting of a diamine, triamine, tetraamine, and pentaamine, wherein the polyamine is H₂N-Q-NH₂, wherein Q is C₁-C₁₀ alkyl, cycloalkyl, C₁-C₁₀ heteroalkyl, or cycloheteroalkyl, each of which is optionally substituted, wherein the mixing is carried out at a temperature in a range of from 10° C. to 30° C. for at least one minute;
after the mixing, adding lignin as a solution and an epoxy-based crosslinker.
